(19) United States
(12) Patent Application Publication
(10) Pub. No.: US 2014/0222999 A1
(43) Pub. Date: Aug. 7, 2014

(54) METHOD FOR THE TESTING OF SERVICE APPLICATIONS IN A VALUE ADDED SERVER OF A COMMUNICATION NETWORK

(71) Applicants: Duncan Sample, Huntingdon (GB); Jeremy Johnson, GyeongGi-Do (KR); Carlos Manzanares Sancho, Tampere (FI); Irving Benjamin Cordova, San Jose, CA (US); Mikhael Harswanto Tanutama, San Jose, CA (US); Joao Martins, Carnaxide (PT); Ivo Rodrigues, Rana (PT); Marc Heide, Berlin (DE); Tri Wasono Adi Nugroho, Sunnyvale, CA (US); Konrad Garlikowski, Wroclaw (PL); Lukasz Jastrzebski, Cupertino, CA (US); Beata Bartoszewska-Karas, Wroclaw (PL); Ahmer Javaid, Reigate (GB); Vaughn Eisler, Parker, CO (US)

(72) Inventors: Duncan Sample, Huntingdon (GB); Jeremy Johnson, GyeongGi-Do (KR); Carlos Manzanares Sancho, Tampere (FI); Irving Benjamin Cordova, San Jose, CA (US); Mikhael Harswanto Tanutama, San Jose, CA (US); Joao Martins, Carnaxide (PT); Ivo Rodrigues, Rana (PT); Marc Heide, Berlin (DE); Tri Wasono Adi Nugroho, Sunnyvale, CA (US); Konrad Garlikowski, Wroclaw (PL); Lukasz Jastrzebski, Cupertino, CA (US); Beata Bartoszewska-Karas, Wroclaw (PL); Ahmer Javaid, Reigate (GB); Vaughn Eisler, Parker, CO (US)

(73) Assignee: NOKIA SIEMENS NETWORKS OY, Espoo (FI)

(21) Appl. No.: 13/985,384

(22) PCT Filed: Feb. 15, 2011
(86) PCT No.: PCT/FI11/50144

§ 371 Date: Nov. 26, 2013

(51) Int. Cl. H04L 12/26

(52) U.S. Cl. CPC H04L 43/10
USPC 709/224

(57) ABSTRACT

The invention relates to an application server and a method. The application server comprises a resolver which reserves a subscriber number prefix for test target applications. The resolver associates an address of an application server with the prefix in a memory and resolves subscriber numbers containing the prefix into the address using the memory. A network element simulator listens to a port, which has a port number which is also used in communicating with the network element being simulated. A test target application communicates with the simulator instead of the network element being simulated via a protocol stack in the application server. An application layer binding is used to route incoming messages to the test target application.

### BACKGROUND OF THE INVENTION

1. Field of the Invention

The invention relates to the testing of new services in a communication system. Particularly, the invention relates to a method for the testing of service applications in a value-added server of a communication network.

2. Description of the Related Art

The introduction of new value-added services to telecommunications networks requires significant testing before the new service may be deployed in an actual live network. Traditionally, the new services must have been tested in specific test platforms which are isolated from the actual operator networks. This entails that developers for value-added services have been forced to invest in costly test platforms. In many cases the cost may be prohibitive for small companies. Even for operators themselves the maintaining of separate test platforms is costly and requires significant resources. On the other hand it may be dangerous to experiment with new services in a live operator network. In the worst case the operation of the network may be disrupted for at least some subscribers due to, for example, infinitely forking session invitations or looping call setup requests. In some cases there is a need to develop separate versions of the program code for implementing a new service, one for a test platform and one for the actual network environment. The need to have separate program code versions complicates software development. The use of compiler switches may lead to program code that is difficult to read and understand which may become a further source for errors. Yet another problem with existing test platforms is that the definition of test cases is difficult. By manually entering test data in character format it is difficult to define test cases that reflect, for example, the movement of a subscriber within the network coverage area. The also requires significant effort of the test engineers responsible for defining the test cases.

Due to the aforementioned factors it would be beneficial to be able to test new services in an actual value-added application server which is also simultaneously used to execute services already in production and actually processing requests from subscribers.

### SUMMARY OF THE INVENTION

According to an aspect of the invention, the invention is a method, comprising: reserving a subscriber number prefix for at least one test target application; associating an address of an application server with the prefix in a memory; listening to a port by a network element simulator application, the port having a port number which is also used in communicating with the network element being simulated by the network element simulator application; creating an application layer binding of at least one subscriber number having the prefix to the test target application; receiving a first request message comprising a first subscriber number having the prefix; selecting the test target application based on the application layer binding; forming a second request message comprising the first subscriber number in the test target application, in response to the first request message; resolving the first subscriber number into the address using the memory; providing the second request message and the address to a protocol stack; delivering the second request message to the network element simulator application from the protocol stack via the port; generating a second response message in the network element simulator application; retrieving information from a test database using at least part of the first subscriber number; and generating a second response message for the test target application using the information retrieved.

According to a further aspect of the invention, the invention is a method comprising: reserving a subscriber number prefix for at least one test target application; receiving, in an application server, a first request message comprising a first subscriber number having the prefix; providing the first request message to a test target application in the application server based on a mapping of the first subscriber number to an identifier of the test target application; forming a second request message comprising the first subscriber number, in response to the first request message in the test target application; routing the second request message to a network element simulator by a request router in the application server; receiving the second request message at the network element simulator in the application server; retrieving information from a test database using at least part of the first subscriber number by the network element simulator; generating a second response message for the test target application using the information retrieved in the network element simulator; and delivering the second response message to the test target application.

According to a further aspect of the invention, the invention is a method comprising: reserving a subscriber number prefix for at least one test target application; forming a first request message comprising a first subscriber number having the subscriber number prefix in a test target application; routing the first request message to a network element simulator by a request router in the application server; receiving the first request message at the network element simulator in the application server; retrieving information from a test database using at least part of the first subscriber number by the network element simulator; generating a first response message for the test target application using the information retrieved in the network element simulator; and routing the first response message to the test target application using a mapping of at least part of the first subscriber number to an identifier of the test target application.

According to a further aspect of the invention, the invention is an application server, comprising: at least one processor configured to reserve a subscriber number prefix for at least one test target application, to associate an address of an application server with the prefix in a memory, to listen to a port by a network element simulator application, the port having a port number which is also used in communicating with the network element being simulated by the network element simulator application, to create an application layer binding of at least one subscriber number having the prefix to the test target application, to receive a first request message comprising a first subscriber number having the prefix, to select the test target application based on the application layer binding, to form a second request message comprising the first subscriber number in the test target application, in response to the first request message, to resolve the first subscriber number into the address using the memory, to provide the second request message and the address to a protocol stack, to deliver the second request message to the network element simulator application from the protocol stack via the port, to generate a second response message in the network element simulator application, to retrieve information from a test database using at least part of the first subscriber number and to generate a second response message for the test target application using the information retrieved.

According to a further aspect of the invention, the invention is an application server, comprising: at least one processor configured to reserve a subscriber number prefix for at least one test target application, to receive a first request message comprising a first subscriber number having the prefix in an application server, to provide the first request message to a test target application in the application server based on a mapping of the first subscriber number to an identifier of the test target application, to form a second request message comprising the first subscriber number, in response to the first request message in the test target application, to route the second request message to a network element simulator by a request router in the application server, to receive the second request message at the network element simulator in the application server, to retrieve information from a test database using at least part of the first subscriber number by the network element simulator, to generate a second response message for the test target application using the information retrieved in the network element simulator and to deliver the second response message to the test target application.

According to a further aspect of the invention, the invention is an application server, comprising a processor configured to reserve a subscriber number prefix for at least one test target application, to form a first request message comprising a first subscriber number having the subscriber number prefix in a test target application, to route the first request message to a network element simulator by a request router in the application server, to receive the first request message at the network element simulator in the application server, to retrieve information from a test database using at least part of the first subscriber number by the network element simulator, to generate a first response message for the test target application using the information retrieved in the network element simulator and to route the first response message to the test target application using a mapping of at least part of the first subscriber number to an identifier of the test target application.

According to a further aspect of the invention, the invention is a computer program comprising code adapted to cause the following when executed on a data-processing system: reserving a subscriber number prefix for at least one test target application; associating an address of an application server with the prefix in a memory; listening to a port by a network element simulator application, the port having a port number which is also used in communicating with the network element being simulated by the network element simulator application; creating an application layer binding of at least one subscriber number having the prefix to the test target application; receiving a first request message comprising a first subscriber number having the prefix; selecting the test target application based on the application layer binding; forming a second request message comprising the first subscriber number in the test target application, in response to the first request message; resolving the first subscriber number into the address using the memory; providing the second request message and the address to a protocol stack; delivering the second request message to the network element simulator application from the protocol stack via the port; generating a second response message in the network element simulator application; retrieving information from a test database using at least part of the first subscriber number; and generating a second response message for the test target application using the information retrieved.

According to a further aspect of the invention, the invention is a computer program comprising code adapted to cause the following when executed on a data-processing system: reserving a subscriber number prefix for at least one test target application; receiving a first request message comprising a first subscriber number having the prefix in an application server; providing the first request message to a test target application in the application server based on a mapping of the first subscriber number to an identifier of the test target application; forming a second request message comprising the first subscriber number, in response to the first request message in the test target application; routing the second request message to a network element simulator by a request router in the application server; receiving the second request message at the network element simulator in the application server; retrieving information from a test database using at least part of the first subscriber number by the network element simulator; generating a second response message for the test target application using the information retrieved in the network element simulator; and delivering the second response message to the test target application.

According to a further aspect of the invention, the invention is a computer program comprising code adapted to cause the following when executed on a data-processing system: reserving a subscriber number prefix for at least one test target application; forming, in a test target application, a first request message comprising a first subscriber number having the subscriber number prefix; routing the first request message to a network element simulator by a request router in the application server; receiving the first request message at the network element simulator in the application server; retrieving information from a test database using at least part of the first subscriber number by the network element simulator; generating a first response message for the test target application using the information retrieved in the network element simulator; and routing the first response message to the test target application using a mapping of at least part of the first subscriber number to an identifier of the test target application.

In one embodiment of the invention, the method further comprises creating an instance of the test target application to process the service request message, in response to the selecting of the test target application. The creation may be performed by an application protocol entity, for example, a Hypertext Transfer Protocol (HTTP) entity or Session Initiation Protocol (SIP) entity. Such an entity may perform message parsing and message formatting on behalf of an application implementing a value-added service.

In one embodiment of the invention, the method further comprises executing at least one service application accessible by a call processing server serving a plurality of mobile subscribers, in addition to the test target application. The service applications accessible by the call processing server serving a plurality of mobile subscribers may be described as applications in production.

In one embodiment of the invention, the method further comprises converting the first subscriber number into a domain name before resolving the first subscriber number into the address. The conversion may be performed by the test target application.

In one embodiment of the invention, the memory comprises a domain name system resolver library and may comprise a domain name system server.

In one embodiment of the invention, the network element simulator application simulates at least one of a call processing server, a gateway mobile location server and a home subscriber server.

In one embodiment of the invention, the selecting of the test target application based on the application layer binding is performed in an application protocol entity.

In one embodiment of the invention, the test database comprises position data associated with a test subscriber identified with the first subscriber number. The position data may be, for example, geographic position coordinates such as GPS coordinates, a street address together with a zip code, or a cell identifier.

In one embodiment of the invention, the method further comprises: presenting a graphical user interface to a tester, the graphical user interface window comprising a map representing at least part of the coverage area of a mobile network; receiving from the graphical user interface at least one indication of at least one position of the user identified with the first subscriber number; and storing the at least one position to the test database. In one embodiment of the invention, the at least one indication is provided as a timed sequence of position changes according to which the position of the user identified with the first subscriber number is changed in the test database.

In one embodiment of the invention, the resolution means comprises a domain name system resolver library.

In one embodiment of the invention, the resolution means comprises a domain name system server.

In one embodiment of the invention, the network element simulator means simulates at least one of a call processing server, a gateway mobile location server and a home subscriber server.

In one embodiment of the invention, the test database comprises position data associated with a test subscriber identified with the first subscriber number.

In one embodiment of the invention, the resolution means may be any request router function or number analysis function, which is used to store the association.

In one embodiment of the invention, in a request router function, the IP address of the application server is stored to a result record of a data structure that is traversed digit-by-digit. The data structure may be a subscriber number analysis tree.

The data structure is adapted to store nodes for digits associated with the prefix so that the analysis of a subscriber number with the prefix leads to the result record storing the IP address of the server.

In one embodiment of the invention, the request router function may also use a sequential file or database table to store associations between subscriber numbers or subscriber number prefixes and IP addresses. The subscriber numbers or subscriber number prefixes may be stored in the file or table as character, octet or nibble strings.

In one embodiment of the invention, the application server is communicatively connected to a call processing server within a communication system.

In one embodiment of the invention, the second request message is routed to the network element simulator by the request router using an application identifier or an address and possibly a port number.

The application identifier or the address and/or the port number may be obtained by analyzing at least the prefix of the first subscriber number.

In one embodiment of the invention, the providing of the first request message to a test target application, based on a mapping of the first subscriber number to an identifier of the test target application, uses a mapping table or file that associates a complete or partial Mobile Subscriber ISDN (MSISDN) number to an identifier of the test target application. The test target application identifier comprise at least one of a character string, Uniform Resource Identifier (URI), an IPv4 address, an IPv6 address, a port number or a process identifier or an application name.

In one embodiment of the invention, the communication system comprises a mobile communication network. In one embodiment of the invention, the communication system comprises at least one of a Global System of Mobile Communications (GSM) network and a Universal Mobile Telephone System (UMTS) network. The mobile station may be, for example, a GSM mobile station or a UMTS mobile station with a dual mode or multimode functionality to support different access types.

In one embodiment of the invention, the computer program is stored on a computer readable medium. The computer readable medium may be a removable memory card, a removable memory module, a magnetic disk, an optical disk, a holographic memory or a magnetic tape. A removable memory module may be, for example, a USB memory stick, a PCMCIA card or a smart memory card.

The embodiments of the invention described hereinbefore may be used in any combination with each other. Several of the embodiments may be combined together to form a further embodiment of the invention. A method, a communication system, a network node or a computer program to which the invention is related may comprise at least one of the embodiments of the invention described hereinbefore.

The benefits of the invention are related to reduced complexity by avoiding specific application server reserved only for testing. The reliability of new services is improved by being able to test them in a real environment. These factors lead to reduced costs for the operator and service developers.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating a Universal Mobile Telecommunications System (UMTS) with an application server in one embodiment of the invention;

FIG. 2A is a flow chart illustrating a first part of a method for the testing of value-added services in one embodiment of the invention;

FIG. 2B is a flow chart illustrating a second part of a method for the testing of value-added services in one embodiment of the invention;

FIG. 2C is a flow chart illustrating a method for the testing of value-added services in one embodiment of the invention, wherein a value-added service originates a message towards a network element simulator; and

FIG. 3 is a block diagram illustrating an application server in one embodiment of the invention.

### DETAILED DESCRIPTION OF THE EMBODIMENTS

Reference will now be made in detail to the embodiments of the present invention, examples of which are illustrated in the accompanying drawings.

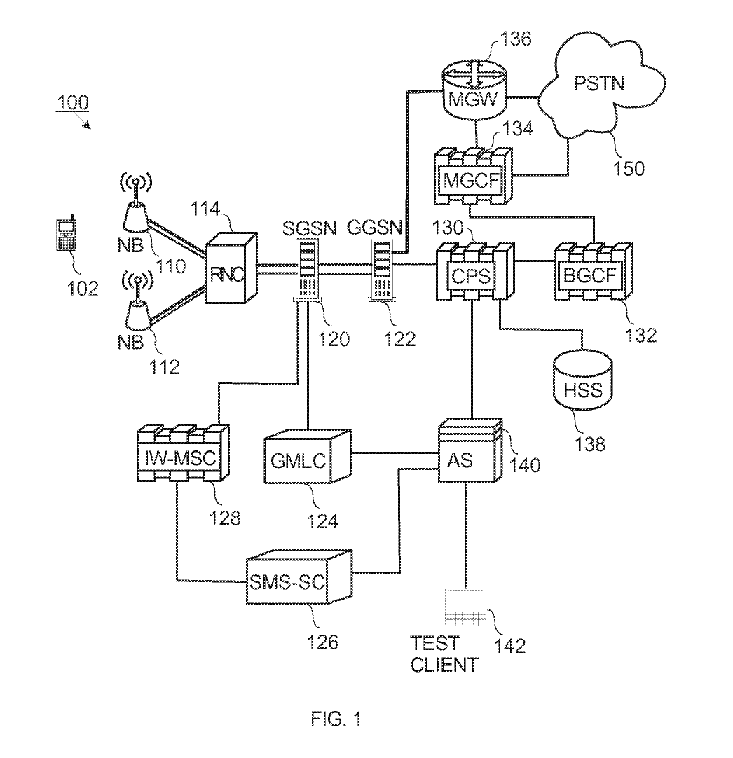

FIG. 1 is a block diagram illustrating a Universal Mobile Telecommunications System (UMTS) network 100 with a value-added server 140 in one embodiment of the invention. It should be noted that the UMTS network is selected for illustrative purposes and the invention is not restricted to any specific standard. The IP multimedia architecture for UMTS and GPRS mobile communication networks is referred to as an IP Multimedia Subsystem (IMS). In FIG. 1 there is shown a mobile station 102, which communicates with a Radio Network Controller (RNC) 114 within a Radio Access Network (RAN) (not shown). Normally communication occurs via a NodeB such as NodeB 110 or NodeB 112. The radio access network may also be, for example, a 2G GSM/EDGE Radio Access Network (GERAN), 3G UMTS Radio Access Network (UTRAN) or a 4G Evolved UTRAN (EUTRAN). An IP Connectivity Access Network (IP-CAN) functionality connected to the access network via RNC 114 comprises at least a Serving GPRS Support Node (SGSN) 120 and a Gateway GPRS Support Node (GGSN) 122. An IP connectivity access network can also been seen as to comprise both a packet switched core network functionality and the access network. The main issue is that an IP-CAN provides IP connectivity to user terminals towards an IP network such as the Internet or an Intranet. SGSN 120 performs all mobility management related tasks and communicates with a Home Subscriber Server (HSS) 138 in order to obtain subscriber information. GGSN 122 provides GPRS access points for each network to which there is connectivity from GPRS. There is an access point, for example, to a Media Gateway (MGW) 136 and to a Call Processing Server (CPS) 130. The access point to MGW 136 carries user plane media component related packets, whereas the access point to CPS 130 carries signaling packets that comprise, most notably, Session Initiation Protocol (SIP) messages. There may be several call processing servers in several roles that participate in call or multimedia session processing. The contact point to an IP-CAN is called a Proxy Call State Control Function (P-CSCF) (not shown). The access point for CPS 130 is used to convey signaling traffic pertaining to IP multimedia and voice over IP. GGSN 122 establishes Packet Data Protocol (PDP) contexts, which are control records associated with a mobile subscriber such as mobile station 102. A PDP context provides an IP address for packets received from or sent to mobile station 102. A PDP context has also associated with it a UMTS bearer providing a certain QoS for mobile station 102. In GGSN 124 there is a primary PDP context for the signaling packets associated mobile station 102. For the user plane data packets carrying at least one IP flow there is established at least one secondary PDP context. The at least one IP flow is established between a calling terminal and a called terminal in association with an IP multimedia session. An IP flow carries a multimedia component, in other words a media stream, such as a voice or a video stream in one direction. For voice calls at least two IP flows are required, one for the direction from the calling terminal to the called terminal and one for the reverse direction. In this case an IP flow is defined as a quintuple consisting of a source port, a source address, a destination address, a destination port and a protocol identifier.

The communication system illustrated in FIG. 1 comprises also the IP Multimedia Subsystem (IMS) functionality. The IMS is used to set-up multimedia sessions over IP-CAN. The network functionalities supporting IMS comprise at least one Proxy Call State Control Function (P-CSCF), at least one Inquiring Call State Control Function (I-CSCF), at least one Serving Call State Control Function S-CSCF, at least one Breakout Gateway Control Function (BGCF) 132 and at least one Media Gateway Control Function (MGCF) 134. The P-CSCF, I-CSCF and S-CSCF functionalities are represented by CPS 130 in FIG. 1, even though they may also be separate network elements in one embodiment of the invention. As part of the IMS there is also at least one Home Subscriber Server (HSS) 138. There is also at least one Application Server (AS) 140, which provides a variety of value-added services for mobile subscribers served by the IP multimedia subsystem (IMS).

CPS 130 as a P-CSCF receives signaling plane packets from GGSN 124. Session Initiation Protocol (SIP) signaling messages are carried in the signaling plane packets. The signaling message is processed by CPS 130 as the P-CSCF, which determines the correct serving network for the mobile station 102 that sent the signaling packet. The determination of the correct serving network is based on a home domain name provided from mobile station 102. Based on the home domain name is determined the correct I-CSCF. The I-CSCF hides the topology of the serving network from the networks, in which mobile station 102 happens to be roaming. In FIG. 1 CPS 130 is also assumed to be the I-CSCF. The I-CSCF may take contact to home subscriber server 138, which returns the name of the S-CSCF, which is used to determine the address of the S-CSCF to which the mobile station 102 is to be registered. If I-CSCF must select a new S-CSCF for mobile station 102, home subscriber server 138 returns required S-CSCF capabilities for S-CSCF selection. In FIG. 1 CPS 130 is also assumed to act as the S-CSCF. Upon receiving a registration, the CPS 130 as the S-CSCF obtains information pertaining to the profile of the mobile station 102 from HSS 138. The information returned from HSS 138 may be used to determine the required trigger information that is used as criterion for notifying an Application Server (AS) 140. AS 140 may also be referred to as a value-added server or a service node. The trigger criteria are also referred to as filtering criteria. Application server 140 may be notified on events relating to incoming registrations or incoming session initiations. Application server 140 may communicate with CPS 130 using the ISCinterface. The acronym ISC stands for IP multimedia subsystem Service Control interface. The protocol used on ISC interface may be SIP. AS 140 may alter SIP INVITE message contents that it receives from CPS 130. The modified SIP INVITE message is returned back to CPS 130.

If the session to be initiated is targeted to a PSTN 150 subscriber or a circuit switched network subscriber, the SIP INVITE message is forwarded to a BGCF 132. BGCF 132 determines the network in which interworking to PSTN 150 or the circuit switched network should be performed. In case PSTN interworking is to be performed in the current network, the SIP INVITE message is forwarded to MGCF 134 from BGCF 132. In case PSTN interworking is to be performed in another network, the SIP INVITE message is forwarded from BGCF 132 to a BGCF in that network (not shown). MGCF 134 communicates with MGW 136. The user plane packets carrying a media bearer or a number of interrelated media bearers for the session are routed from GGSN 122 to MGW 136 as illustrated in FIG. 1. Generally, in FIG. 1 user plane is illustrated with a thick line and control plane with thinner line.

In FIG. 1 there is also a Gateway Mobile Location Server (GMLC) 124 which acts serves position information regarding subscribers within the radio access network. Depending on requested position quality, the position information provided from GMLC 124 may be a geographic location or just a cell identifier. There is also illustrated a test client node 142, which executes a test simulator that simulates signaling related to service requests associated with a mobile subscriber. The test signaling from test client node 142 may be, for example, SIP signaling emulating SIP signaling normally received from CPS 130. The signaling may also be Hypertext Transfer Protocol (HTTP) signaling that emulates HTTP signaling received from mobile station 102 via GPRS to AS 140. Generally, the test signaling may be any mobile network related signaling, for example, Short Message Service (SMS) signaling or Simple Object Adapter Protocol (SOAP) signaling. There is also a Short Message Service (SMS) Service Centre (SMS-SC) 126 and an Interworking Mobile Switching Centre (IW-MSC) 128. The SMS-SC may be used by AS 140 to send short messages towards subscriber such as mobile station 102. The short messages are routed via IW-MSC 128 and SGSN 120.

The embodiments of the invention described hereinbefore in association with FIG. 1 may be used in any combination with each other. Several of the embodiments may be combined together to form a further embodiment of the invention.

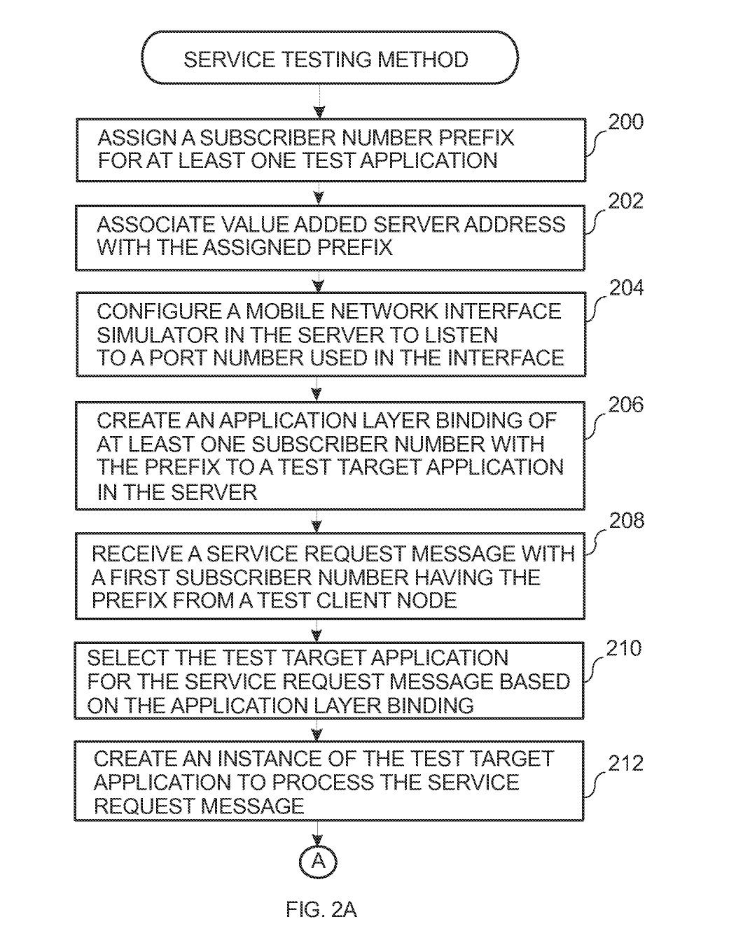

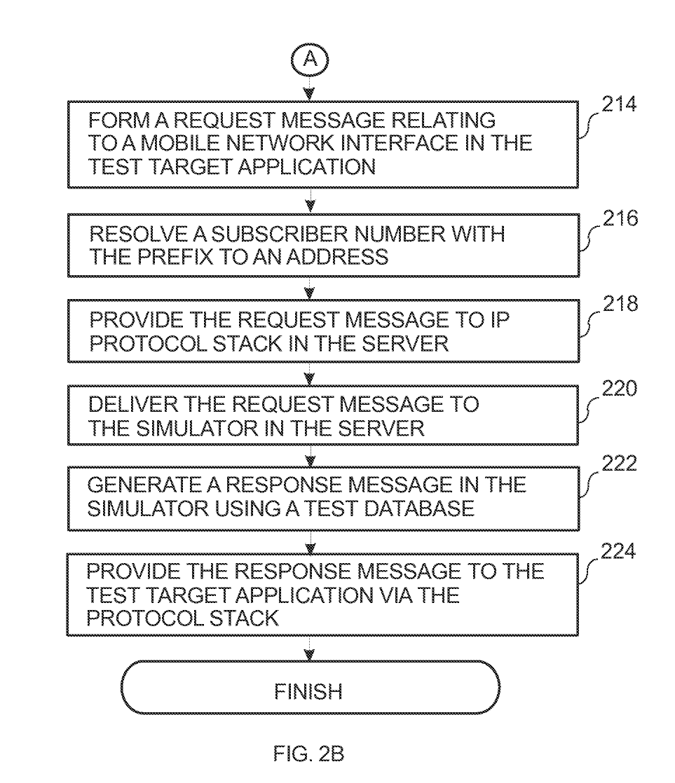

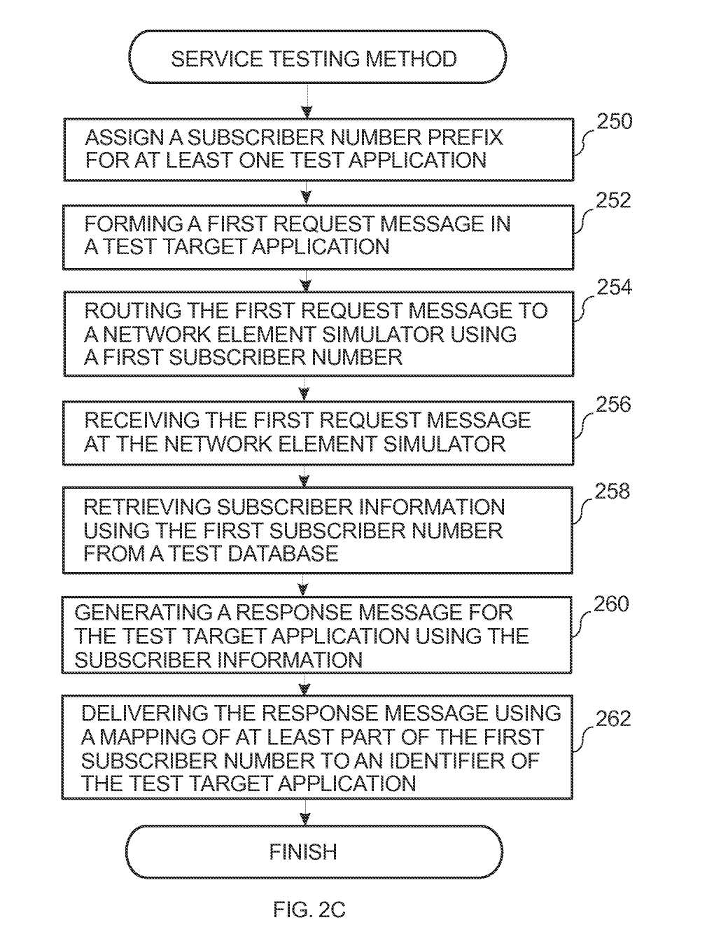

FIG. 2A is a flow chart illustrating a first part of a method for the testing of value-added services in one embodiment of the invention.

At step 200, a subscriber number prefix is assigned for test target applications. In one embodiment of the invention, the subscriber number is an E.164 subscriber number, which may also be represented as a TEL-URL. In one embodiment of the invention, the prefix comprises an unallocated country code, for example, +000, wherein the character “+” indicates international Type of Number (TON). In one embodiment of the invention, the prefix comprises a country code and an unallocated network code.

At step 202, an IP address for an application server is associated with the prefix. The association may be performed via a mapping database that maps at least part of a subscriber number to the IP address for the application server. In one embodiment of the invention, the prefix may be translated to the DNS ENUM format in accordance with, for example, the Internet Engineering Task Force (IETF) RFC 2916. In one embodiment of the invention, the association may be direct so that the prefix indicates directly a record containing the IP address for the application server or indirect so that the prefix first indicates a second domain name that is subsequently translated in the domain name system to the IP address of the application server.

In one embodiment of the invention, instead of the domain name system any other request router function or number analysis system may be used to store the association.

In one embodiment of the invention, in a request router function, the IP address of the application server is stored to a result record of a data structure that is traversed digit-by-digit. The data structure may be a subscriber number analysis tree.

The data structure is adapted to store nodes for digits associated with the prefix so that the analysis of a subscriber number with the prefix leads to the resuit record storing the IP address of the server.

At step 204, a mobile network interface simulator in the application server starts to listen to a port number used in the interface. By a mobile network interface is meant a reference interface to a specific network element type such as a GMLC, an SMS-SC, a charging server, a multimedia messaging server, an instant message server, an HSS, an HLR, an MSC, an MSC server, an SGSN, a CPS or any SIP server. By listening to the port number the mobile network interface simulator acts as an internal surrogate for an actual service located in a remote network element that uses the same port number for incoming requests. The reference interfaces are defined, for example, in 3G Partnership Project (3GPP) specifications.

At step 206, is created an application layer binding of at least one subscriber number having the prefix to a test target application hosted in the application server. The binding may be stored in a binding database or table stored in a memory of the application server. The binding may also be stored to a remote node accessed from the application server. The binding may also be stored in a service provisioning database that defines a number of services associated with each of the at least one subscriber number. By checking the service provisioning database a correct service may be selected based on parameters in a service request message received.

At step 208, a service request message comprising a first subscriber number with the prefix is received at the application server. The service request may originate from a test client node. The service request message may be processed first at an IP stack and provided from there to an application protocol function such as an HTTP engine.

At step 210, the test target application is selected based on the application layer binding in the application server by using the first subscriber number as index. The application protocol function may determine using the binding created at step 206 the test target application by reading the binding database or table.

At step 212, an instance of the test target application is created to process the service request message. The creation may involve the creation of an application process or thread for a test target application handler.

FIG. 2B is a flow chart illustrating a second part of a method for the testing of value-added services in one embodiment of the invention.

At step 214, the instance of the test target application forms a remote request message relating to a mobile network interface. The mobile network interface may be, for example, an interface towards a SIP server such as CPS 130 illustrated in FIG. 1.

At step 216, the first subscriber number is analyzed, for example, by a DNS resolver function in the application server to obtain the IP address associated with the prefix. The DNS resolver may be a library in association with the test target application.

Instead of DNS resolver, a request router function may analyze the first subscriber number and obtain the IP address associated with the prefix.

At step 218, the remote request message is provided to IP protocol stack from test target application, for example, via an application layer function.

At step 220, the IP protocol stack, by determining that the IP address refers to same node, provides the remote request message to the simulator application within the application server, due to the fact that the simulator application listens to the port number specified in the remote request message. The same port number may be used by the network element simulated when processing actual requests from value-added service applications in production.

At step 222, the simulator application analyses the remote request message and, based on its test case database, generates a response message to be delivered to the test target application.

At step 224, the simulator application sends the response message to the test target application via the IP protocol stack.

Thereupon, the method is finished.

FIG. 2C is a flow chart illustrating a method for the testing of value-added services in one embodiment of the invention, wherein a value-added service originates a message towards a network element simulator.

At step 250 in an application server is reserved a subscriber number prefix for at least one test target application.

At step 252 is formed a first request message comprising a first subscriber number having the subscriber number prefix in a test target application.

At step 254 the first request message is routed to a network element simulator by a request router in the application server.

At step 256 the first request message is received at the network element simulator in the application server.

At step 258 subscriber information is retrieved from a test database using at least part of the first subscriber number by the network element simulator. The at least part of the first subscriber number may be used as an index or a key to access information associated with it in the test database.

At step 260 is generated a first response message for the test target application using the information retrieved by the network element simulator.

At step 262 the first response message is delivered to the test target application. The first response message is routed to the test target application using a mapping of at least part of the first subscriber number to an identifier of the test target application. The at least part of the first subscriber number may be the prefix or the entire first subscriber number. The identifier of the test target application may comprise an IP address and a port number.

Thereupon, the method is finished.

The embodiments of the invention described hereinbefore in association with FIGS. 2A, 2B and 2C may be used in any combination with each other. Several of the embodiments may be combined together to form a further embodiment of the invention.

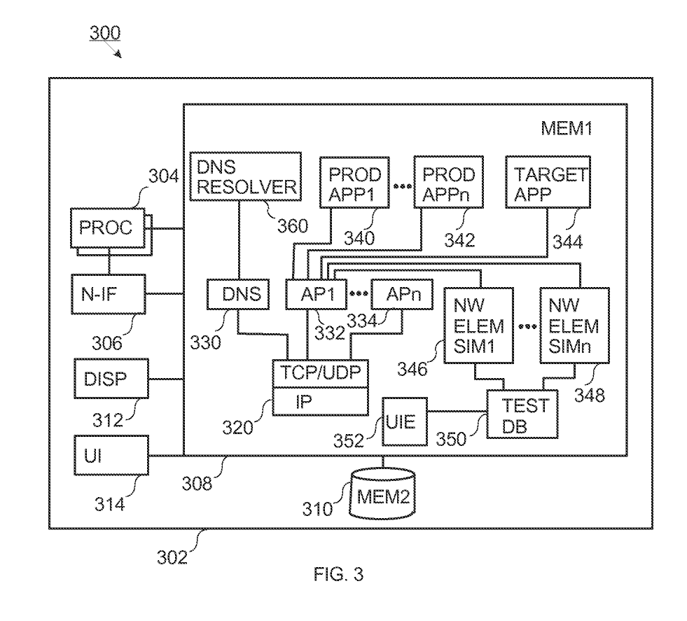

FIG. 3 is a block diagram illustrating an application server in one embodiment of the invention.

The application server may execute the method illustrated in FIG. 2. The application server may be the application server 140 illustrated in FIG. 1.

In FIG. 3 there is illustrated an application server 300. Application server 300 comprises at least one processor, for example, processor 304, at least one secondary memory, for example, secondary memory 310 and at least one primary memory, for example, primary memory 308. Application server 300 may also comprise any number of other processors and any number secondary memory units. There may also be other primary memories with separate address spaces. Application server 300 comprises also a network interface 306. Network interface 306 may, for example, be a cellular radio interface, a Wireless Local Area Network (WLAN) interface, a local area network interface or a wide area network interface. Network interface is used to communicate to the Internet or locally to at least one computer. Application server may also comprise a display interface 312 that may comprise a graphics card and a socket for an external display. The display interface may also be a network card for connecting via a data network to an external user interface client such as a browser in a remote computer.

The application server may also comprise a user interface 314 such as a USB interface for a mouse or any other pointer device or keyboard. User interface 314 may also be a directly connected keyboard and/or a pointer device.

Processor 304 or at least one similarly configured processor within application server 300 executes a number of software entities stored at least partly in primary memory 308. Primary memory 308 comprises an IP protocol stack 320, a DNS protocol entity 330, DNS resolver entity 360, a first application protocol entity 332, a second application protocol entity 334, a first production application 340, a second production application 342 and a test target application 344. Primary memory 308 comprises also a first simulator application 346 and a second simulator application 348. Primary memory 308 comprises also a test database 350 for use by the simulator applications. The simulator applications each simulate a specific mobile network reference interface, that is, a specific network element type such as, for example, a GMLC.

In one embodiment of the invention, there is a user interface entity 352 communicatively connected to the test database 350 for presenting a user interface for managing the information in the test database. The user interface entity may present a graphical user interface to testers. The graphical user interface may present a map representing at least part of the coverage area of a mobile network. The graphical user interface may provide user interface tools that allow pointing of a position of a test subscriber on the map and entering of the position to the test database regarding the test subscriber. The graphical user interface may also provide tools that allow the specifying of a timed route for a test subscriber. The timed route information is processed by the graphical user interface to change the geographic or cell level position of the test user in the test database at specified moments in time. User interface entity 352 may be web server application that communicates with a browser in a remote client computer. The communication is performed, for example, using the HTTP or HTTPS protocols. The maps may be provided as image files to the browser. The location selections may be communicated as coordinates on the image and translated into actual geographic coordinates by the web server application, that is, user interface entity 352.

In one embodiment of the invention, a time sequence of test subscriber locations may be provided from a browser based application in a client computer (not shown) to the web server application within application server 300 using at least one message. A client computer based browser application such as an ActiveX component, a Java applet or a Java Script may be used by a tester to specify a time sequence of geographic positions of a test subscriber. The tester using the browser application selects a sequence of locations on the map, for example, with a pointer device and specifies a time for each of them or a time that elapses when changing to the next location. The browser application form a time sequence that it provides in parts or en-block to the web server application, that is, user interface entity 352. The time sequence, in other words, a time series may comprise a list of entries comprising a time and/or date and associated geographical coordinates or, alternatively, of entries comprising a time-of-day and associated coordinates of the map image.

In one embodiment of the invention, IP protocol stack 320 is communicatively connected to DNS protocol entity 330, first application protocol entity 332 and second application protocol entity 334. IP protocol stack is configured to receive a packet comprising a service request message comprising a first subscriber number with a prefix, which is assigned for test target applications, to decapsulate the service request message and to provide the service request message to first application protocol entity 332.

First simulator application 346 is configured to start to listen to a port number used in the interface it simulates. By listening to the port number the mobile network interface simulator acts as an internal surrogate for an actual service located in a remote network element that uses the same port number for incoming requests.

First application protocol entity 332 is configured to store an application layer binding of at least one subscriber number having the prefix to test target application 344. The binding may be stored in a binding database or table stored in a memory of the application server. The binding may also be stored to a remote node accessed from the application server.

First application protocol entity 332 is also configured to select test target application 344 based on the application layer binding in the application server by using the first subscriber number as index.

First application protocol entity 332 is also configured to cause the creation of an instance of the test target application to process the service request message. The creation may involve the creation of an application process or thread for a test target application handler.

Test target application 344 is configured to form a remote request message relating to a mobile network interface and to analyze, for example, by a DNS resolver entity 360 to obtain the IP address associated with the prefix. The DNS resolver may be a library in association with the test target application. Instead of DNS resolver, a request router function may analyze the first subscriber number and obtain the IP address associated with the prefix or the entire first subscriber number. This means that DNS resolver entity 360 may also be request router function.

Test target application 344 is also configured to provide the remote request message to IP protocol stack 344 via first application protocol entity 332.

In one embodiment of the invention, instead of the DNS protocol entity 330 any TCP/IP or UDP/IP or SCTP/IP based protocol entity may be used.

IP protocol stack 320 is configured to, by determining that the IP address refers to same node, provide the remote request message to first simulator application 346, due to the fact that the simulator application listens to the port number specified in the remote request message.

First simulator application 346 is configured to analyze the remote request message and, based on its test case database, to generate a response message to be delivered to the test target application, and to send the response message to the test target application via the IP protocol stack 320.

In one embodiment of the invention, a subscriber number prefix is reserved for at least one test target application. An address of the application server is associated with the prefix in a memory. A first request message is received in the application server, the first request message comprising a first subscriber number having the prefix. The first request message is provided to a test target 344 application among the at least one test target application in the application server 300. A second request message comprising the first subscriber number is formed, in response to the first request message, in the test target application. The first subscriber number is resolved into the address using the memory. Thereafter, the second request message is sent by the test target application. A second request message is received at a network element simulator, for example, first simulator application 346. Information is retrieved from a test database 350 using at least part of the first subscriber number by the network element simulator. A second response message is generated for the test target application using the information retrieved by the network element simulator. Thereupon, the second request message is delivered to the test target application via the protocol stack.

In one embodiment of the invention, a network element simulator application is configured to listening to a port, the port having a port number which is also used in communicating with the network element being simulated by the network element simulator application.

In one embodiment of the invention, an application layer binding of at least one subscriber number having the prefix to the test target application is created and the test target application is selected based on the application layer binding.

In one embodiment of the invention, a subscriber number prefix is reserved for at least one test target application. An application reference for a network element simulator is associated with the prefix in a memory, the application reference comprising a network element identifier and an application identifier. A first request message comprising a first subscriber number having the prefix is received in an application server. The first request message is provided to a test target application among the at least one test target application in the application server. A second request message comprising the first subscriber number is formed, in response to the first request message in the test target application. The first subscriber number is resolved into the application reference using the memory. The second request message is routed using the application reference to a network element simulator by a request router in the application server. The second request message is received at the network element simulator in the application server. Information is retrieved from a test database using at least part of the first subscriber number by the network element simulator. A second response message is generated for the test target application using the information retrieved in the network element simulator. The second request message is delivered to the test target application.

In one embodiment of the invention the request router is a middleware component which maintains information concerning application reference to network node identifier and application identifier mappings. The application identifier may be a process or thread identifier. The network node identifier may be a network address such as an IP address or a logical name such as a domain name.

In one embodiment of the invention the middleware may be a Common Object Request Broker Architecture (CORBA) middleware. The middleware may also be a Microsoft™ .NET request broker, a Java Enterprise Beans request broker or a Microsoft™ DCOM request broker. The application reference may also be an object reference that identifies a callback method within the network element simulator that may be used to provide messages to the network element simulator.

The application reference may be, for example, a domain name, a URL or an arbitrary application identifier. The application reference may also be, for example, an Interoperable Object Reference (IOR), a Corba object reference or a Corba Location (CORBALOC).

First application protocol entity 332 and second application protocol entity 334 may represent different protocols, for example, HTTP, HTTPS, SIP, HTTPR, BEEP or RTSP. The SIP, HTTP and HTTPS messages may comprise a further message structure such as Simple Object Adapter Protocol (SOAP) which specifies an extensible markup language based message format to carry remote method invocations and results.

The entities within application server 300 such as IP protocol stack 320, a DNS protocol entity 330, DNS resolver library 360, a first application protocol entity 332, a second application protocol entity 334, a first production application 340, a second production application 342, a test target application 344, a first simulator application 346, and a second simulator application 348, user interface entity 352 may be implemented in a variety of ways. They may be implemented as processes executed under the native operating system of the network node or the network node. The entities may be implemented as separate processes or threads or so that a number of different entities are implemented by means of one process or thread. A process or a thread may be the instance of a program block comprising a number of routines, that is, for example, procedures and functions. The entities may be implemented as separate computer programs or as a single computer program comprising several modules, libraries, routines or functions implementing the entities. The program blocks are stored on at least one computer readable medium such as, for example, a memory circuit, a memory card, a holographic memory, magnetic or optic disk. Some entities may be implemented as program modules linked to another entity. The entities in FIG. 3 may also be stored in separate memories and executed by separate processors, which communicate, for example, via a message bus or an internal network within the network node. An example of such a message bus is the Peripheral Component Interconnect (PCI) bus. The internal network may be, for example, a local area network. The entities may also be partly or entirely implemented as hardware, such as ASICS or FPGAs. An entity may be a software component or a combination of software components.

The embodiments of the invention described hereinbefore in association with FIG. 3 may be used in any combination with each other. Several of the embodiments may be combined together to form a further embodiment of the invention.

The exemplary embodiments of the invention can be included within any suitable device, for example, including any suitable servers, workstations, PCs, laptop computers, PDAs, Internet appliances, handheld devices, cellular telephones, wireless devices, other devices, and the like, capable of performing the processes of the exemplary embodiments, and which can communicate via one or more interface mechanisms, including, for example, Internet access, telecommunications in any suitable form (for instance, voice, modem, and the like), wireless communications media, one or more wireless communications networks, cellular communications networks, 3 G communications networks, 4 G communications networks Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware art(s). For example, the functionality of one or more of the components of the exemplary embodiments can be implemented via one or more hardware devices, or one or more software entities such as modules.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be implemented by the preparation of application-specific integrated circuits or by interconnecting an appropriate network of conventional component circuits, as will be appreciated by those skilled in the electrical art(s).

As stated above, the components of the exemplary embodiments can include computer readable medium or memories according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

The embodiments of the invention described hereinbefore in association with FIGS. 1, 2A, 2B, 3 and 4 may be used in any combination with each other. Several of the embodiments may be combined together to form a further embodiment of the invention.

It is obvious to a person skilled in the art that with the advancement of technology, the basic idea of the invention may be implemented in various ways. The invention and its embodiments are thus not limited to the examples described above; instead they may vary within the scope of the claims.

1. A method, comprising:
reserving a subscriber number prefix for at least one test target application;
associating an address of an application server with the prefix in a memory;
listening to a port by a network element simulator application, the port having a port number which is also used in communicating with the network element being simulated by the network element simulator application;
creating an application layer binding of at least one subscriber number having the prefix to the test target application;
receiving a first request message comprising a first subscriber number having the prefix;
selecting the test target application based on the application layer binding;
forming a second request message comprising the first subscriber number in the test target application, in response to the first request message;
resolving the first subscriber number into the address using the memory;
providing the second request message and the address to a protocol stack;
delivering the second request message to the network element simulator application from the protocol stack via the port;
generating a second response message in the network element simulator application;
retrieving information from a test database using at least part of the first subscriber number; and
generating a second response message for the test target application using the information retrieved.

2. The method according to claim 1, the method further comprising:
creating an instance of the test target application to process the service request message, in response to the selecting of the test target application.

3. The method according to claim 1, the method further comprising:
executing at least one service application accessible by a call processing server serving a plurality of mobile subscribers, in addition to the test target application.

4. The method according to claim 1, the method further comprising:
converting the first subscriber number into a domain name before resolving the first subscriber number into the address.

5. The method according to claim 1, wherein the memory comprises a domain name system resolver library.

6. The method according to claim 1, wherein the memory comprises a domain name system server.

7. The method according to claim 1, wherein the network element simulator application simulates at least one of a call processing server, a gateway mobile location server, a home subscriber server, a charging server, a short message service center, an instant messaging server, an electronic mail server and a multimedia messaging server.

8. The method according to claim 1, wherein the selecting of the test target application based on the application layer binding is performed in an application protocol layer entity.

9. The method according to claim 1, wherein the test database comprises position data associated with a test subscriber identified with the first subscriber number.

10. The method according to claim 1, the method further comprises:
presenting a graphical user interface to a tester, the graphical user interface window comprising a map representing at least part of the coverage area of a mobile network;
receiving from the graphical user interface at least one indication of at least one position of the user identified with the first subscriber number; and
storing the at least one position to the test database.

11. The method according to claim 10, wherein the at least one indication is provided as a timed sequence of position changes according to which the position of the user identified with the first subscriber number is changed in the test database.

12. The method according to claim 1, wherein the test database comprises a prepaid balance associated with a test subscriber identified with the first subscriber number.

13. A method, comprising:
reserving a subscriber number prefix for at least one test target application;
receiving in an application server a first request message comprising a first subscriber number having the prefix;
providing the first request message to a test target application in the application server based on a mapping of the first subscriber number to an identifier of the test target application;
forming a second request message comprising the first subscriber number, in response to the first request message in the test target application;
routing the second request message to a network element simulator by a request router in the application server;
receiving the second request message at the network element simulator in the application server;
retrieving information from a test database using at least part of the first subscriber number by the network element simulator;
generating a second response message for the test target application using the information retrieved in the network element simulator; and
delivering the second response message to the test target application.

14. A method, comprising:
reserving a subscriber number prefix for at least one test target application;
forming a first request message comprising a first subscriber number having the subscriber number prefix in a test target application;
routing the first request message to a network element simulator by a request router in the application server;
receiving the first request message at the network element simulator in the application server;
retrieving information from a test database using at least part of the first subscriber number by the network element simulator;
generating a first response message for the test target application using the information retrieved in the network element simulator; and
routing the first response message to the test target application using a mapping of at least part of the first subscriber number to an identifier of the test target application.

15. An application server, comprising:
at least one processor configured to reserve a subscriber number prefix for at least one test target application, to associate an address of an application server with the prefix in a memory, to listen to a port by a network element simulator application, the port having a port number which is also used in communicating with the network element being simulated by the network element simulator application, to create an application layer binding of at least one subscriber number having the prefix to the test target application, to receive a first request message comprising a first subscriber number having the prefix, to select the test target application based on the application layer binding, to form a second request message comprising the first subscriber number in the test target application, in response to the first request message, to resolve the first subscriber number into the address using the memory, to provide the second request message and the address to a protocol stack, to deliver the second request message to the network element simulator application from the protocol stack via the port, to generate a second response message in the network element simulator application, to retrieve information from a test database using at least part of the first subscriber number and to generate a second response message for the test target application using the information retrieved.

16. An application server, comprising:
a processor configured to reserve a subscriber number prefix for at least one test target application, to receive a first request message comprising a first subscriber number having the prefix in an application server, to provide the first request message to a test target application in the application server based on a mapping of the first subscriber number to an identifier of the test target application, to form a second request message comprising the first subscriber number, in response to the first request message in the test target application, to route the second request message to a network element simulator by a request router in the application server, to receive the second request message at the network element simulator in the application server, to retrieve information from a test database using at least part of the first subscriber number by the network element simulator, to generate a second response message for the test target application using the information retrieved in the network element simulator and to deliver the second response message to the test target application.

17. An application server, comprising:
a processor configured to reserve a subscriber number prefix for at least one test target application, to form a first request message comprising a first subscriber number having the subscriber number prefix in a test target application, to route the first request message to a network element simulator by a request router in the application server, to receive the first request message at the network element simulator in the application server, to retrieve information from a test database using at least part of the first subscriber number by the network element simulator, to generate a first response message for the test target application using the information retrieved in the network element simulator and to route the first response message to the test target application using a mapping of at least part of the first subscriber number to an identifier of the test target application.

18. A computer program comprising code adapted to cause the following when executed on a data-processing system:
reserving a subscriber number prefix for at least one test target application;
associating an address of an application server with the prefix in a memory;
listening to a port by a network element simulator application, the port having a port number which is also used in communicating with the network element being simulated by the network element simulator application;
creating an application layer binding of at least one subscriber number having the prefix to the test target application;
receiving a first request message comprising a first subscriber number having the prefix;
selecting the test target application based on the application layer binding;
forming a second request message comprising the first subscriber number in the test target application, in response to the first request message;
resolving the first subscriber number into the address using the memory;
providing the second request message and the address to a protocol stack;
delivering the second request message to the network element simulator application from the protocol stack via the port;
generating a second response message in the network element simulator application;
retrieving information from a test database using at least part of the first subscriber number; and
generating a second response message for the test target application using the information retrieved.

19. The computer program according to claim 18, wherein said computer program is stored on a computer readable medium.

20. A computer program comprising code adapted to cause the following when executed on a data-processing system:
reserving a subscriber number prefix for at least one test target application;
receiving a first request message comprising a first subscriber number having the prefix in an application server;
providing the first request message to a test target application in the application server based on a mapping of the first subscriber number to an identifier of the test target application;
forming a second request message comprising the first subscriber number, in response to the first request message in the test target application;
routing the second request message to a network element simulator by a request router in the application server;
receiving the second request message at the network element simulator in the application server;
retrieving information from a test database using at least part of the first subscriber number by the network element simulator;
generating a second response message for the test target application using the information retrieved in the network element simulator; and
delivering the second response message to the test target application.

21. The computer program according to claim 20, wherein said computer program is stored on a computer readable medium.

22. A computer program comprising code adapted to cause the following when executed on a data-processing system:
reserving a subscriber number prefix for at least one test target application;
forming a first request message comprising a first subscriber number having the subscriber number prefix in a test target application;
routing the first request message to a network element simulator by a request router in the application server;
receiving the first request message at the network element simulator in the application server;
retrieving information from a test database using at least part of the first subscriber number by the network element simulator;
generating a first response message for the test target application using the information retrieved in the network element simulator; and
routing the first response message to the test target application using a mapping of at least part of the first subscriber number to an identifier of the test target application.

23. The computer program according to claim 22, wherein said computer program is stored on a computer readable medium.
